(19) United States
(12) Patent Application Publication
(10) Pub. No.: US 2004/0165083 A1
(43) Pub. Date: Aug. 26, 2004

(54) Active digital image capture device

(75) Inventor: Hui-Huang Chang, Hsinchu (TW)

Correspondence Address: BRUCE H. TROXELL, 5205 LEESBURG PIKE, SUITE 1404, FALLS CHURCH, VA, 22041, US

(73) Assignee: Realtek Semiconductor Corp.

(21) Appl. No.: 10/770,410

(22) Filed: Feb. 4, 2004

(30) Foreign Application Priority Data
Feb. 21, 2003 (TW) 92103587

(51) Int. Cl. H04N 5/232

(52) U.S. Cl. 348/222.1; 348/207.2

(57) ABSTRACT

The present invention provides an active image capture device, comprising: an image capture unit capable of capture image for generating an image data; and a processing unit connecting to the image capture unit; wherein when the active image capture device is connected to an image forming device, the processing unit is used for outputting the image data to the image forming device and further controlling the operation of the image forming device.

### FIELD OF THE INVENTION

The present invention relates to an image capture device, and more particularly, to a digital image capture device capable of outputting imaging data actively.

### BACKGROUND OF THE INVENTION

In recent years, in associated with the progress of image technology, digital image capture devices, such as digital cameras and digital camcorders, have become popular. Typically, the digital image capture devices capture images electronically and ultimately store the image as binary data in a memory. Flash memory is one of the most common storage devices for use in digital cameras.

However, conventional methods of downloading or transferring the image data from the memory within the digital image capture device for displaying or printing are not convenient for users. Please refer to FIG. 1A, which is a schematic diagram depicting a conventional architecture of accessing image data stored in the image storage device 15 of a digital camera 1. The image storage device 15 is manually removable from the digital camera 1 and plugged into the card reader 19 connecting to a personal computer 2 such that a user can access the image data stored in the image storage device 15 for processing through operating the personal computer 2 or for transferring the image data to a printer 31 connecting to *the personal computer 2. Please refer to FIG. 1B, which is a schematic diagram depicting another conventional architecture of accessing image data stored in the image storage device 15 of a digital camera 1. Also, the image storage device 15 is manually removed from the digital camera 1 and plugged into a printer 32 equipped with a card reader 19 such that a user can access the image data stored in the image storage device 15 for processing or for printing through operating the printer 32. Please refer to FIG. 1C, which is a schematic diagram depicting yet another conventional architecture for accessing image data stored in the image storage device 15 of a digital camera 1. The digital camera 1 is equipped with an output interface 14, such as an USB interface or an IEEE 1394 interface, that the output interface 14 is connected to the I/O interface 334 of an active printer 33 with a communication medium, such as a cable 18. Hence, a user can access the image data stored in the digital camera 15 through operating the active printer 33.

However, the conventional methods described above for outputting the stored image data have several disadvantages. For both the methods with reference to FIGS. 1A and 1B, the image store device, i.e. a memory card, must be manually removed form the digital camera that are not convenient to operate. For the method with reference to FIG. 1C, the active printer is needed which is a lot more expensive than an ordinary printer. In addition, in the conventional methods described above, the digital camera is a passive image data providing device which can only be employed by other image processing devices.

### SUMMARY OF THE INVENTION

One of the objectives of the present invention is to provide an active image capture device capable of not only capturing images, but also being an active image data provider which can actively output image data to other image processing devices.

Another one of the objectives of the present invention is to provide an image data providing system that is convenient to use, that is, the image data providing system capable of outputting the image data without being controlled by other image processing device, such as a personal computer. The image data providing system of the present invention can provide data actively to the common image display device, such as an ordinary printer.

In order to achieve the above objectives, the present invention provides an active image capture device, comprising: an image capture unit, capable of capture image for generating an image data; and a processing unit, coupling to the image capture unit; wherein when the active image capture device is coupled to an imaging forming device, the processing unit is used for outputting the image data to the imaging forming device and further controlling the operation of the imaging forming device.

These and other objectives of the claimed invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1A is a schematic diagram depicting a conventional architecture of accessing image data stored in the image storage device of a digital camera.

FIG. 1B is a schematic diagram depicting another conventional architecture of accessing image data stored in the image storage device of a digital camera.

FIG. 1C is a schematic diagram depicting yet another conventional architecture of accessing image data stored in the image storage device of a digital camera.

FIG. 2 is a schematic diagram of an active digital image capture device according to the embodiment of the present invention.

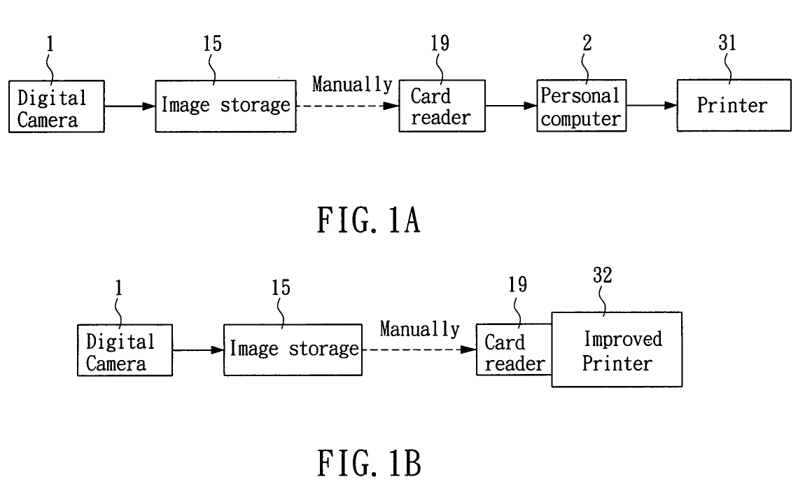

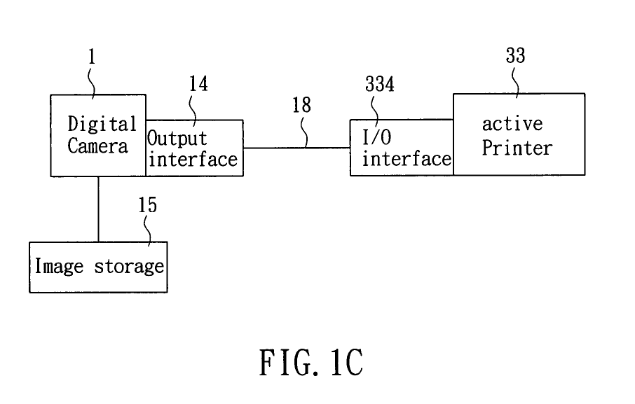

### DESCRIPTION OF THE PREFERRED EMBODIMENT

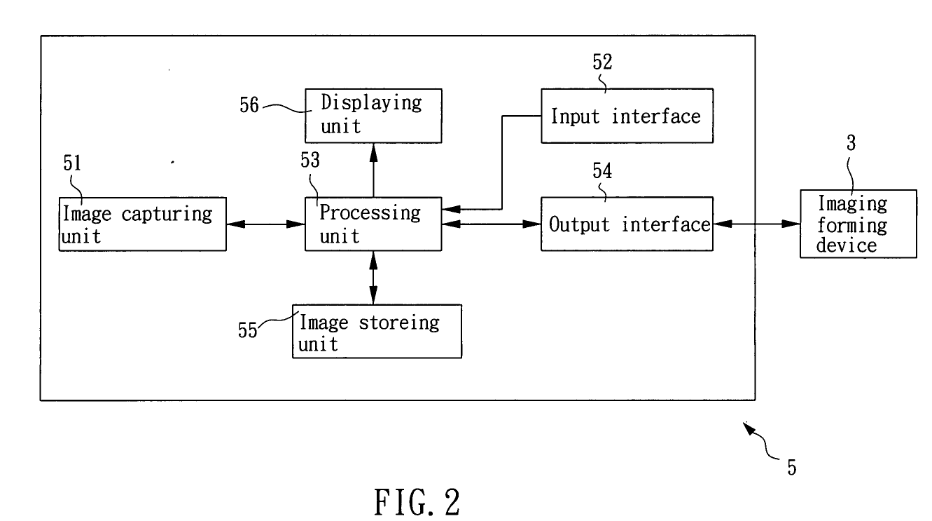

Please refer to FIG. 2, which is a schematic diagram of an active digital image capture device according to the embodiment of the present invention. The active digital image capture device, such as a digital camera 5, comprises a image capture unit 51, an input interface 52, a processing unit 53, an output interface 54, an image data storing unit 55, and a displaying unit 56. The image capture unit 51 including a camera lens for capturing the predefined image. The captured image is inputted to the processing unit 53 to generate an image data corresponding to the captured image. Then, the image data is stored in the image data storing unit 55.

The active digital camera 5 further includes an input interface 52 for receiving controlling commands, such as image processing, output data format setting, image outputting, or printing, so as to control the operation of the active digital camera 5. In this embodiment, the input interface 52 includes a command panel having command buttons and/or keys. The user can inputting the command to control the operation of the active digital camera 5 through the input interface. The processing unit 53 is capable of processing the image data according to the controlling command inputted from the input interface 52. For example, the processing unit 53 has the capability of executing the image processing operations, such as image zooming, color enhancing, image coding, and image compressing, etc. Moreover, according to the format of the outer imaging forming device 3, such as a common printer, coupled to the active digital camera 5. The processing unit 53 is capable of converting the image data into the formats suitable to the connected imaging forming device 3. For instance, if the imaging forming device 3 is a common printer 31, the processing unit 53 can transfer the image data from the red-green-blue (RGB) format to the cyan-magenta-yellow-black (CMYK) format used by the common printer 31 before outputting the image data to the common printer 31. Also, in printing, the image data must be halftone processed such that shades of color are reproduced by tiny dots of varying diameter so as to acquire a better printing quality. If the outer imaging forming device 3 is a monitor, the processing unit 53 only need to perform a simply transformation on the image data to be displayed on the monitor according to the resolution of the monitor. The output interface 54 is for transferring the converted image data to the outer imaging forming device 3. The transferring can be accomplished using a cable, a optic fiber, a network, an USB interface, an IEEE 1394 interface, a Bluetooth communication and/or wireless LAN communication, etc. The active digital camera 5 further includes a displaying unit 56 for displaying the processed image data. A user is able to directly preview the image in processing when giving commands to control the image processing operation of the processing unit 53 without outputting the image to the outer imaging forming device 3.

One embodiment of the present invention can be a digital camera, which stores the captured image data in the storing unit 55 thereof. The digital camera can be coupled to the imaging forming device 3 by the output interface 54 so as to transfer the stored image data to the imaging forming device 3, such as a computer, a printer, or a multi-function peripheral (MFP). The aforementioned output interface 54 can be implemented by a USB interface, an IEEE 1394 interface, etc. If a USB interface is employed as the output interface, the digital camera should be the USB host and the imaging forming device 3 should be the USB device. However, if the USB interface adopts the USB on-the-go (USB OTG) specification, both the USB peripherals have the capability to be the host.

The conventional digital image capture device, such as a digital camera, can only act as a passive image data provider that the image data stored in the image data storing unit is outputted through the controlling of other imaging forming device, such as a personal computer or an active printer. However, the digital image capture device of the present invention is capable of converting the image data stored therein into a format corresponding to the imaging forming device 3 and further actively transferring the converted image data to the imaging forming device 3 through the output interface 54 without the controlling of the imaging forming device 3. In addition, the user can control the operation of the active digital image capture device to perform the image inputting/outing and various image processing operations via the input interface having functional keys and/or buttons. Thus, the active image capture device of the present invention is able to utilize an ordinary printer to print out a picture without previously processed by a personal computer 2 or using a specified high-level printer. Also, the digital image capture device of the present invention do not require to take out the memory card manually.

While the preferred embodiment of the invention has been set forth for the purpose of disclosure, modifications of the disclosed embodiments of the invention as well as other embodiments thereof may occur to those skilled in the art. Accordingly, the appended claims are intended to cover all embodiments which do not depart from the scope of the invention.

What is claimed is:

1. An image capture apparatus, comprising:
an image capture unit to generate an image data corresponding to an image; and
a processing unit coupled to the image capture unit to process the image data, wherein when the image capture apparatus is coupled to an imaging forming device, the processing unit is for actively outputting the processed image data to the imaging forming device.

2. The image capture apparatus of claim 1, further comprising: an image data storing unit coupled to the processing unit for storing the image data.

3. The image capture apparatus of claim 1, further comprising:
an input interface coupled to the processing unit for receiving a command to control the operation of the processing unit.

4. The image capture apparatus of claim 1, further comprising:
a display module coupled to the processing unit for a user to preview the image data.

5. The image capture apparatus of claim 1, wherein further comprising:
an output interface coupled between the processing unit and the imaging forming device for outputting the processed image data to the imaging forming device.

6. The image capture apparatus of claim 1, wherein the processing operation performed by the processing unit is to convert the image data into a converted image data corresponding to the imaging forming device.

7. The image capture apparatus of claim 6, wherein further comprising:
a configuration storing unit coupled to the processing unit for storing the format of the imaging forming device.

8. The image capture apparatus of claim 5, wherein the output interface is an USB interface and the image capture apparatus is an USB host and the imaging forming device is an USB device.

9. The image capture apparatus of claim 8, wherein the output interface is an USB on-the-go interface.

10. The image capture apparatus of claim 5, wherein the output interface is an IEEE 1394 interface.

11. The image capture apparatus of claim 5, wherein the output interface is a Bluetooth interface.

12. The image capture apparatus of claim 1, wherein the imaging forming device is a personal computer.

13. The image capture apparatus of claim 1, wherein the imaging forming device is a monitor.

14. The image capture apparatus of claim 1, wherein the image capture apparatus is a digital camera.

15. The image capture apparatus of claim 1, wherein the processing operation performed by the processing unit is to convert the image data into the converted image data, and the converted image data includes a printer control language (PCL).

16. A method for outputting an image data form an active digital image capture device, comprising:
generating a image data corresponding to an image through image capturing;
processing the image data; and
outputting the processed image data actively to an image forming device without the controlling of the image forming device when the image forming device is coupled to the active digital capture device.

17. The method of claim 16, wherein the image data processing operation is to convert the image data into a converted image data corresponding to the image forming device.
